(19) United States
(12) Patent Application Publication
(10) Pub. No.: US 2022/0286697 A1
(43) Pub. Date: Sep. 8, 2022

(54) APPARATUS, SYSTEM, AND METHOD FOR VIDEO ENCODING AND LOADING TAPE CARTRIDGES

(71) Applicant: Meta Platforms, Inc., Menlo Park, CA (US)

(72) Inventors: Yunqing Chen, Los Altos, CA (US); Rohan Prakash Mallya, Fremont, CA (US); Lei Feng, Sunnyvale, CA (US); Deepa Palamadai Sundar, Sunnyvale, CA (US); Visalakshi Vaduganathan, Fremont, CA (US); Harikrishna Madadi Reddy, San Jose, CA (US); Jose Gallegos, Omaha, NE (US); Caleb Cotton, Omaha, NE (US); Erik Schaeffer, Omaha, NE (US); Jason Odom, Omaha, NE (US)

(21) Appl. No.: 17/752,596

(22) Filed: May 24, 2022

Related U.S. Application Data
(60) Provisional application No. 63/232,814, filed on Aug. 13, 2021.
(60) Provisional application No. 63/211,183, filed on Jun. 16, 2021.

(51) Int. Cl. H04N 19/423; H04N 19/159; H04N 19/182; H04N 19/176

(52) U.S. Cl. CPC H04N 19/423; H04N 19/159; H04N 19/182; H04N 19/176

(57) ABSTRACT

The disclosed computer-implemented method may include receiving video data to be encoded, determining pixels for a first transform unit (TU) of a first prediction unit (PU) of a square shape of the video data, storing the pixels in a buffer, performing intra-prediction for a second PU by reusing the stored pixels for a second TU of the second PU, and encoding the video data based on the intra-prediction. A system may include a video encoder and/or a tape holder apparatus. The tape holder apparatus may include a cubical tape holder to hold multiple tape cartridges in a stack, wherein a tape cartridge may be inserted into a top of the cubical tape holder. The tape holder apparatus may include a handle and a horizontal slot enabling a single tape cartridge to be pushed out from a bottom of the stack. Various other methods, systems, and apparatuses are also disclosed.

### CROSS REFERENCE TO RELATED APPLICATION

This application claims the benefit of U.S. Provisional Application No. 63/232,814, filed 13 Aug. 2021, which claims the benefit of U.S. Provisional Application No. 63/211,183, filed 16 Jun. 2021, the disclosures of each of which are incorporated, in their entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1A is a flow diagram of an exemplary method for video encoding according to the present disclosure.

FIG. 1B is a block diagram illustrating a video encoder according to the present disclosure.

FIG. 1C is a block diagram illustrating an example implementation of the video encoder according to the present disclosure.

FIG. 1D is a block diagram illustrating shape types for an intra-prediction mode of a video encoder according to the present disclosure.

FIG. 2A is an illustration of a perspective view of an exemplary tape holder apparatus for holding tape cartridges.

FIG. 2B is an illustration of a perspective view of an alternative exemplary tape holder apparatus.

FIG. 2C is an illustration of an alternative perspective view of the alternative exemplary tape holder apparatus.

FIG. 2D is an illustration of a side view of the exemplary tape holder apparatus dispensing exemplary tape cartridges.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Features from any of the embodiments described herein may be used in combination with one another in accordance with the general principles described herein. These and other embodiments, features, and advantages will be more fully understood upon reading the following detailed description in conjunction with the accompanying drawings and claims.

### Example Intra Processing Order for VP9 Transform Units to Share Data Across PUs for Better Performance in Video Hardware Encoders

As used herein, the term “video codec” generally refers to a device that performs encoding (i.e., compression) and decoding (i.e., decompression) of video data. Video data is typically encoded at a transmitter for more efficient transmission and decoded at a receiver for reproduction. Examples of video codecs include, without limitation, MPEG4 and VP9.

VP9 is an open and royalty-free video coding format developed by Google. VP9 competes mainly with MPEG's High Efficiency Video Coding (HEVC/H.265). At first, VP9 was mainly used on Google's video platform YouTube. The emergence of the Alliance for Open Media, and its support for the ongoing development of the successor AV1, of which Google is a part, led to growing interest in the format.

In contrast to HEVC, VP9 support is common among modern web browsers, including Chromium, Google Chrome, Opera, Firefox, Microsoft Edge, and Safari. Android has supported VP9 since version 4.4 KitKat, while iOS/iPadOS added support for VP9 in iOS/iPadOS 14. VP9 is customized for video resolutions greater than 1080p (such as UHD) and also enables lossless compression.

In operation, the VP9 codec encodes a video frame by dividing the frame into rows and columns to achieve coding units called macroblocks, at least some of which may be further split into prediction units (PUs) and transform units (TUs). The VP9 codec employs an inter-prediction mode for motion compensation by using a similar region on previously coded frames close to the current block for prediction. In case no acceptable reference is available, or no motion vector for any available reference gives acceptable prediction results, a block can use intra prediction. For intra prediction, edge (top/top-right, left and top-left) pixels are used to predict the contents of the current block. The exact mechanism through which the edge pixels are filtered to generate the predictor is called the intra prediction mode.

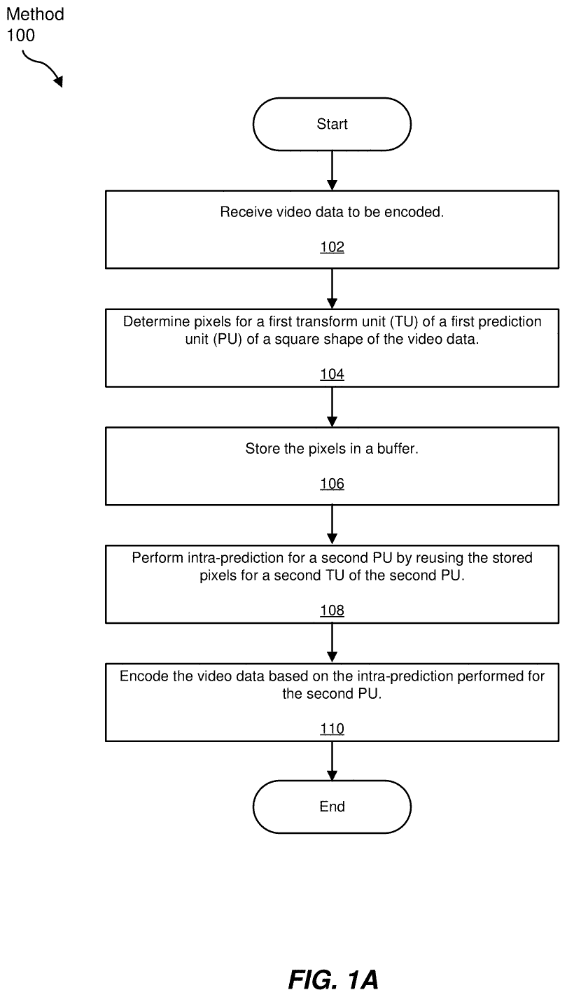

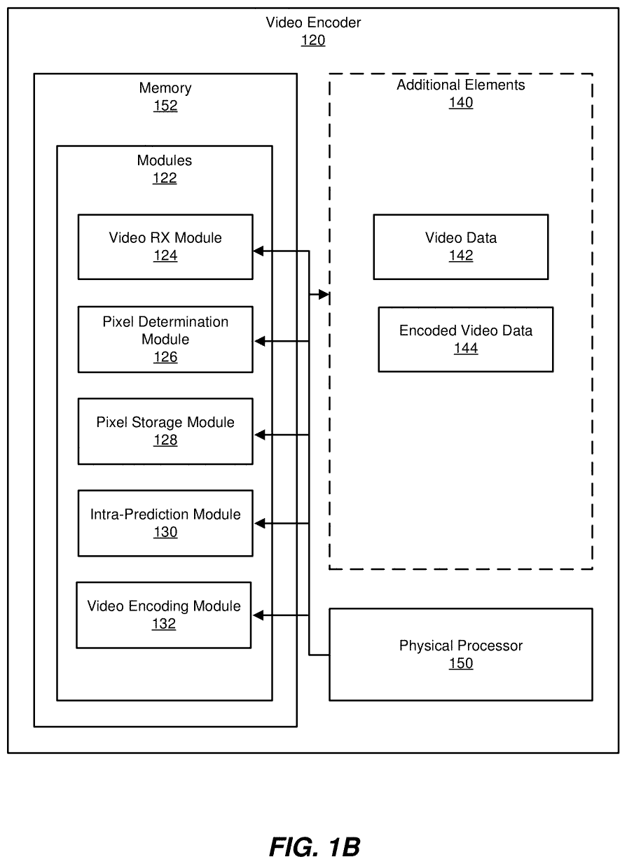

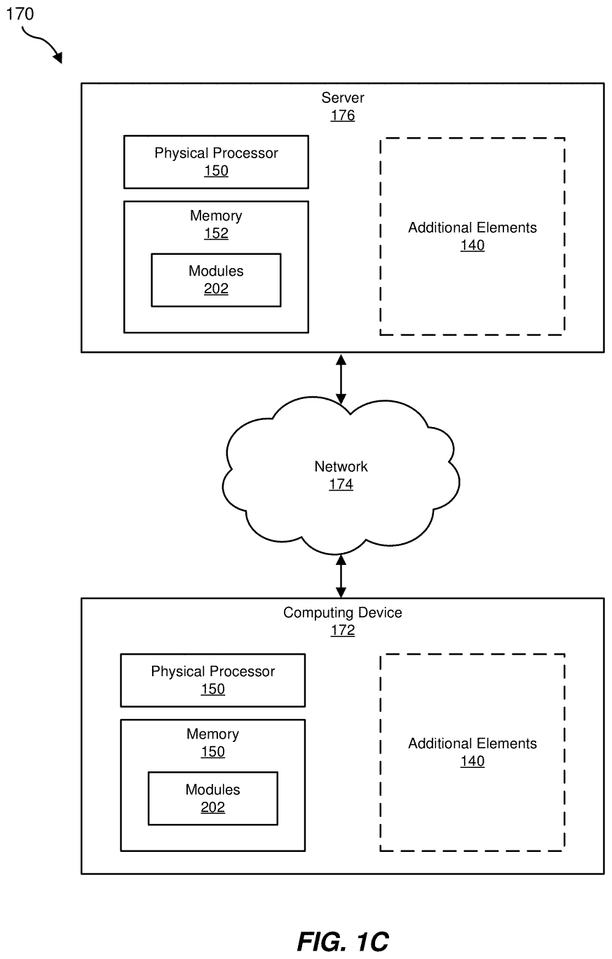

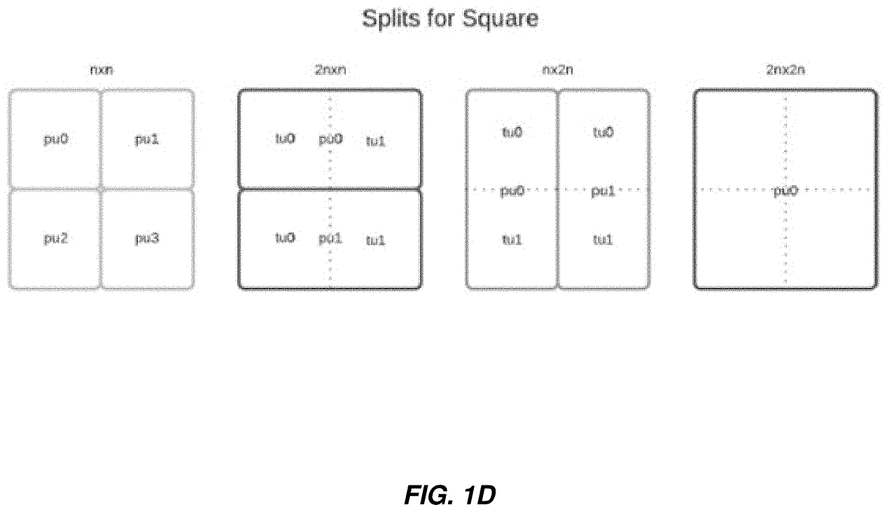

As shown in FIG. 1D, each square shape can be split into the following four shape types, wherein each shape type can have multiple PUs: n×n (4 PUs); 2n×n (2 PUs); n×2n (2 PUs); and 2n×2n (1 PU). These shapes result from the four partitioning modes of VP9 block decomposition: none, horizontal, vertical, and split. None, horizontal, and vertical are all terminal nodes, whereas split recurses down at the next block level (32×32), where each of the 4 sub-blocks goes through a subsequent round of the decomposition process. This process can continue up until the 8×8 block level, where all partitioning modes are terminal, which means 4×4 is the smallest possible block size. At block size 4×4, VP9 supports ten intra-prediction modes: DC, Vertical, Horizontal, TM (True Motion), Horizontal Up, Left Diagonal, Vertical Right, Vertical Left, Right Diagonal, and Horizontal Down.

Within each PU, there can be multiple TUs, and intra-prediction is performed on a transform unit basis and decided on a PU basis. Stated differently, intra-prediction mode is the same for all TUs in a PU. In order to perform intra prediction for a given TU, the reconstructed pixels from the neighboring TUs are needed. Hence there is an algorithmic data dependency. For example, if the neighboring TU is within the same PU, the current TU has to use reconstructed pixels from that neighbor TU for each of the prediction modes of that neighbor. As such, all TUs within a PU have the same mode. Stated differently, tu1 mode 0 should use tu0 mode0 as neighbors, to 1 mode 1 should use tu0 mode1 as neighbors, etc. Alternatively, if the neighboring TU is from a different PU, the current TU has to use reconstructed pixels for the best prediction mode of the neighboring TU/PU. Traditional software and hardware encoders process all PUs independently without sharing any prediction data across PUs. This limitation burns power across the hardware encoder blocks and impacts performance by increasing overall processing times.

The present disclosure is generally directed to a video encoder and/or video encoding process having reduced processing time. As will be explained in greater detail below, embodiments of the present disclosure may share data across TUs of different PU shapes during intra-prediction mode. By buffering neighbor reconstructed pixels (right and left boundary pixels), the reconstructed pixels can be reused across PUs. Thus, transform units can avoid reconstructing pixels that have already been reconstructed by one or more neighbor TUs from different PUs. The encoder may be implemented in hardware for accelerated performance and, thus, achieve improved video data transmission efficiency in computer networks and wireless communications.

The following will provide, with reference to FIGS. 1A-1D, detailed descriptions of the disclosed video encoder and/or video encoding process. For example, a video encoding process is described with reference to FIG. 1A, and a video encoder implementing that process is described with reference to FIG. 1B. An example implementation of the disclosed video encoder is described with reference to FIG. 1C, and various video data square shapes resulting from block partitioning modes are described with reference to FIG. 1D.

FIG. 1A is a flow diagram of an exemplary computer-implemented method 100. The steps shown in FIG. 1A may be performed by any suitable computer-executable code and/or computing system, including the system(s) illustrated in FIGS. 1B and 1C. In one example, each of the steps shown in FIG. 1A may represent an algorithm whose structure includes and/or is represented by multiple sub-steps, examples of which will be provided in greater detail below.

As illustrated in FIG. 1A, at step 102 one or more of the systems described herein may receive, by a computing device, video data to be encoded. The video data may be generated locally, received over a network data connection, and/or retrieved from local memory. Processing may proceed from step 102 to step 104.

As used herein, “video data” generally refers to a stored or transmitted signal that represents a visual image in a manner reproducible by a computing device. Video data may occur as a continuous, analog signal or a representation of such a signal converted into a non-continuous, digital format. In a digital format, the video data can be stored as a series of bits on a hard disk or in computer memory. Types of video data include, without limitation, MPEG video data and VP9 video data.

As used herein, “encoding” generally refers to converting information or a signal into a coded form, such as by compression of video data. Examples of encoding include, without limitation, compression of VP9 video data or compression of MPEG video data.

At step 104 one or more of the systems described herein may determine, by the computing device, pixels for a first transform unit (TU) of a first prediction unit (PU) of a square shape of the video data. For example, the pixels for the first TU may be reconstructed based on information about pixels of neighboring TUs in a same or similar manner as may be carried out during a decoding process, thus predicting what the decoder will be able to determine for a TU by reconstructing pixel data for that TU using reconstructed pixel data of its neighboring TUs. Comparing the reconstructed pixels of a TU to the real pixels of that TU to obtain residuals is part of the compression carried out by the encoding, so that information about pixels that can be reconstructed reliably can be reduced or eliminated in the compressed data. Processing may proceed from step 104 to step 106.

At step 106 one or more of the systems described herein may store, by the computing device, the pixels in a buffer. For example, the reconstructed pixels may be stored in a hardware data buffer. Processing may proceed from step 106 to step 108.

As used herein, “buffer” generally refers to a region of a physical memory storage used to temporarily store data while it is being moved from one place to another. Buffers can be implemented in a fixed memory location in hardware or by using a virtual data buffer in software pointing at a location in the physical memory. In all cases, the data stored in a data buffer are stored on a physical storage medium.

At step 108 one or more of the systems described herein may perform, by the computing device, intra-prediction for a second PU by reusing the stored pixels for a second TU of the second PU. For example, the data stored in the buffer may be read out of the buffer instead of reconstructing those pixels again. In this process, reading out the data of the buffer may be accompanied by reading the data back into the buffer for continued storage and reuse by other TUs that neighbor the first TU. Processing may proceed from step 108 to step 110.

At step 110 one or more of the systems described herein may encode the video data based on the intra-prediction performed for the second PU. For example, the reconstructed pixels for the second TU may be subtracted from the actual pixels of the second TU to obtain a residual. This residual may be employed to compress the video data. Following step 110, the encoded video data may be stored and/or transmitted.

A video encoder may be implemented in any suitable manner. Turning to FIG. 1B, an exemplary video encoder 120 includes at least one physical processor 150, physical memory 152 comprising computer-executable instructions such as modules 122, and additional elements 140, such as received video data 142 and encoded video data 144. When executed by the physical processor, the modules 122 cause physical processor 150 to carry out various operations. For example, video data reception module 124 may execute procedures described above with reference to step 102 of method 100 of FIG. 1A. Additionally, pixel determination module 126 may execute procedures described above with reference to step 104 of method 100 of FIG. 1A. Also, pixel storage module 128 may execute procedures described above with reference to step 106 of method 100 of FIG. 1A. Further, intra-prediction module 130 may execute procedures described above with reference to step 108 of method 100 of FIG. 1A. Further, video encoding module 132 may execute procedures described above with reference to step 110 of method 100 of FIG. 1A.

Example video encoder 120 in FIG. 1B may be implemented in a variety of ways. For example, all or a portion of example video encoder 120 may represent portions of example system 170 in FIG. 1C. As shown in FIG. 1C, system 170 may include a computing device 172 in communication with a server 176 via a network 174. In one example, all or a portion of the functionality of modules 122 may be performed by computing device 172, server 176, and/or any other suitable computing system. As will be described in greater detail below, one or more of modules 122 from FIG. 1B may, when executed by at least one processor of computing device 172 and/or server 176, enable computing device 172 and/or server 176 to perform video encoding. For example, and as will be described in greater detail below, one or more of modules 122 may cause computing device 172 and/or server 176 to encode video data by performing intra-prediction for a second PU by reusing stored pixels determined for a first TU of a first PU for a second TU of the second PU. Computing device 172 and/or server 176 may further transmit the encoded video data over network 174.

Turning to FIG. 1D, the video encoding disclosed herein may perform sharing of data across TUs of different PU shapes in a hardware implementation. Sharing the data across TUs of different PU shapes eliminates the need to repeat the reconstructed pixels generation for all TUs within a PU by allowing some of the TUs across different PUs to share results of pixel reconstruction processing.

Some TUs from different PUs are going to have the same processing mathematically, so they do not need to perform the same processing again. The TUs from different PUs that use them as neighbors can share the reconstructed pixel data for these neighbors. For example, the processing for n×n pu0 tu0 is the same as for: 2n×n pu0 tu0, n×2n pu0 tu0, and 2n×2n pu0 tu0. A special case exists for 64×64 PU with 4 32×32 TU split. In this special case, processing for 2n×n (64×32) pu0 tu1 is the same as for 2n×2n (64×64) tu1. The hardware implementation may thus buffer the neighbor reconstructed pixels (right and left boundary pixels) for the above mentioned TUs to be reused across other PUs.

With the data sharing disclosed above, a video encoder and/or video encoding process may have reduced processing time. For example, embodiments of the present disclosure may share data across TUs of different PU shapes during intra-prediction mode. By buffering neighbor reconstructed pixels (right and left boundary pixels), the reconstructed pixels can be reused across PUs. Thus, transform units can avoid reconstructing pixels that have already been reconstructed by one or more neighbor TUs from different PUs. The encoder may be implemented in hardware for accelerated performance and, thus, achieve improved video data transmission efficiency in computer networks and wireless communications. Although discussed particularly herein with reference to the VP9 codec, it is envisioned that these techniques also may be of benefit with other video codecs that employ an intra-prediction mode.

### EXAMPLE EMBODIMENTS

### Example 1

A computer-implemented method may include receiving, by a computing device, video data to be encoded and determining, by the computing device, pixels for a first transform unit (TU) of a first prediction unit (PU) of a square shape of the video data. The method may additionally include storing, by the computing device, the pixels in a buffer and performing, by the computing device, intra-prediction for a second PU by reusing the stored pixels for a second TU of the second PU. The method may also include encoding the video data based on the intra-prediction performed for the second PU.

### Example 2

A video encoder may include a buffer and a physical processor configured to receive video data to be encoded and determine pixels for a first transform unit (TU) of a first prediction unit (PU) of a square shape of the video data. The physical processor may additionally be configured to store the pixels in the buffer and perform intra-prediction for a second PU by reusing the stored pixels for a second TU of the second PU. The physical processor may also be configured to encode the video data based on the intra-prediction performed for the second PU.

### Example Tape Holder Apparatus for Holding and Loading Tape Cartridges

Data centers and libraries may house large quantities of digital data, which may be retrieved or modified as needed. For example, data may be stored in tape cartridges and housed in data racks so that individual cartridges can be easily loaded or retrieved without needing to access entire libraries of data. In some embodiments, the term “data center” may refer to a facility that houses and/or stores electronic and computing equipment for ongoing computing processes. In some embodiments, the terms “data library” or “tape library” may refer to a repository or archive to store and/or retrieve digital data. In some examples, the term “tape cartridge” may refer to an enclosure containing a length of magnetic tape that may store digital data. For example, a magnetic tape cartridge may include a LINEAR TAPE-OPEN (LTO) cartridge that may be stored or mounted in a data-center storage rack. In some examples, the term “rack” may refer to a physical framework designed to house electronic and/or computing equipment, particularly in a data center. For example, a tape library may utilize one or more racks to house tape cartridges.

When a new tape library is installed, thousands of tape cartridges may potentially be loaded for the new library, and multiple libraries may be installed or modified for a data center. The installation process may be time consuming and physically demanding if each tape cartridge is individually loaded by hand. For example, conventional methods for loading LTO tape cartridges may be a manual process to load each cartridge, and installing a tape library may require the loading process to be repeated 8,319 times. In this example, a single data center site may include over 150 libraries, resulting in a process that is not ergonomic for the person loading the tape cartridges. Additionally, the manual process may increase the risk of dropped or damaged tape cartridges, which may also be costly when tape cartridges need to be replaced.

The present disclosure is generally directed to a tape loading tool for facilitating and improving the loading of tape cartridges, particularly LTO cartridges, into a tape library. As will be explained in greater detail below, embodiments of the present disclosure may by dimensioning a tape holder apparatus to hold multiple cartridges while leaving an exposed bottom opening, enable individual tape cartridges to be pushed out from the bottom opening and mounted to a designated rack or tape library. The disclosed tape holder apparatus may first include a tape holder designed to hold a specified number of tape cartridges. For example, the disclosed tape holder apparatus may include a cubical tape holder, and individual tape cartridges may be inserted from an open top of the tape holder by dropping a flat cartridge into the tape holder. The tape holder apparatus described herein may also include a horizontal opening, open on two sides of the tape holder along the bottom of the tape holder apparatus, that enables individual cartridges to be pushed out, one at a time, to be loaded into a tape library slot. The disclosed tape holder apparatus may then include a handle on the outside of the tape holder that enables easier holding of the tape holder, and therefore enables easier holding of tape cartridges. Furthermore, the disclosed tape holder apparatus may include protrusions that help guide individual cartridges as they are pushed out of the tape holder.

Using the described tape cartridge loading tool, manual installation of tape cartridges may be improved over traditional methods. Specifically, the tape holder apparatus may enable the process of loading tape cartridges into a tape library to be easier and faster than conventional manual methods, which may decrease the amount of time taken to install a tape library. Additionally, by improving the ease of holding multiple cartridges, the disclosed tape holder apparatus may decrease the likelihood of dropped and damaged tape cartridges, thereby also providing cost savings when installing the tape library.

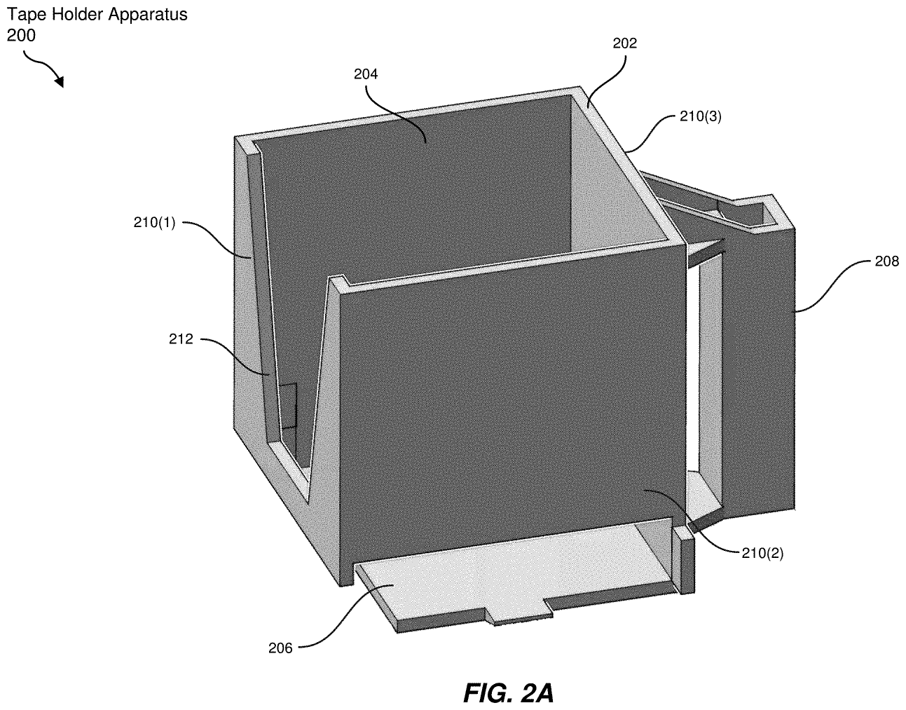

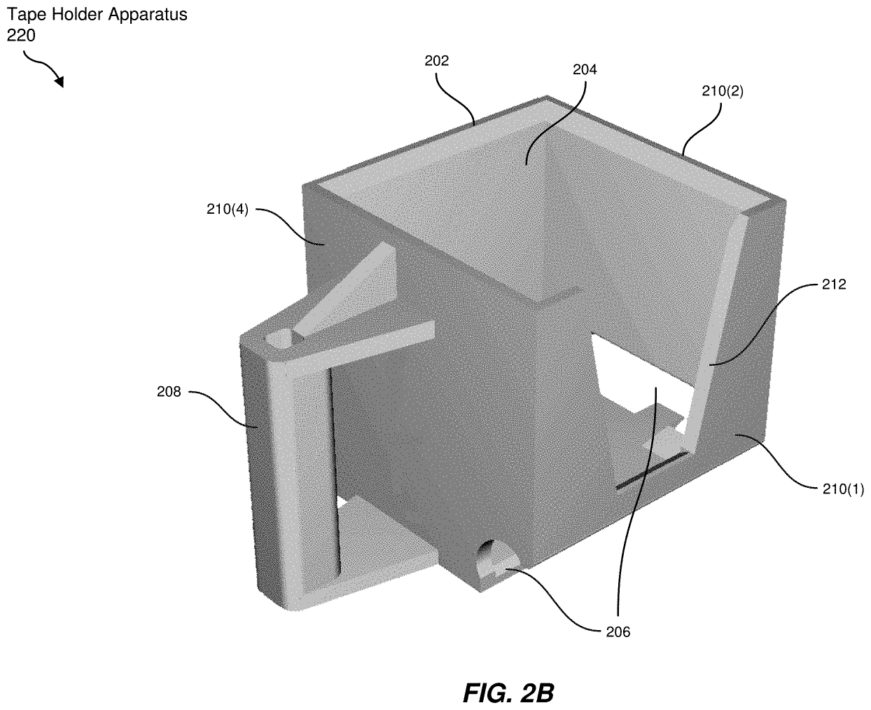

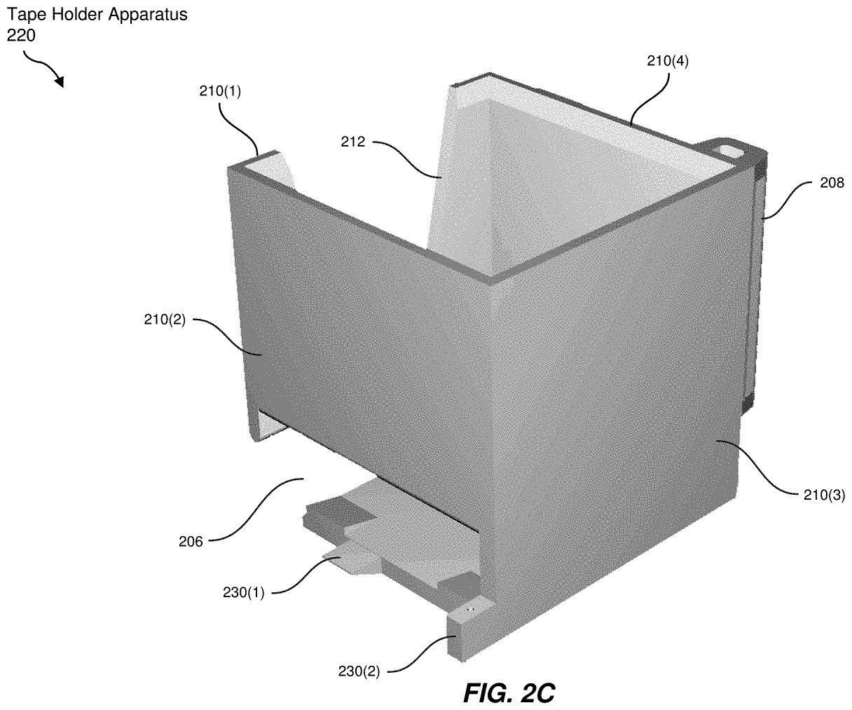

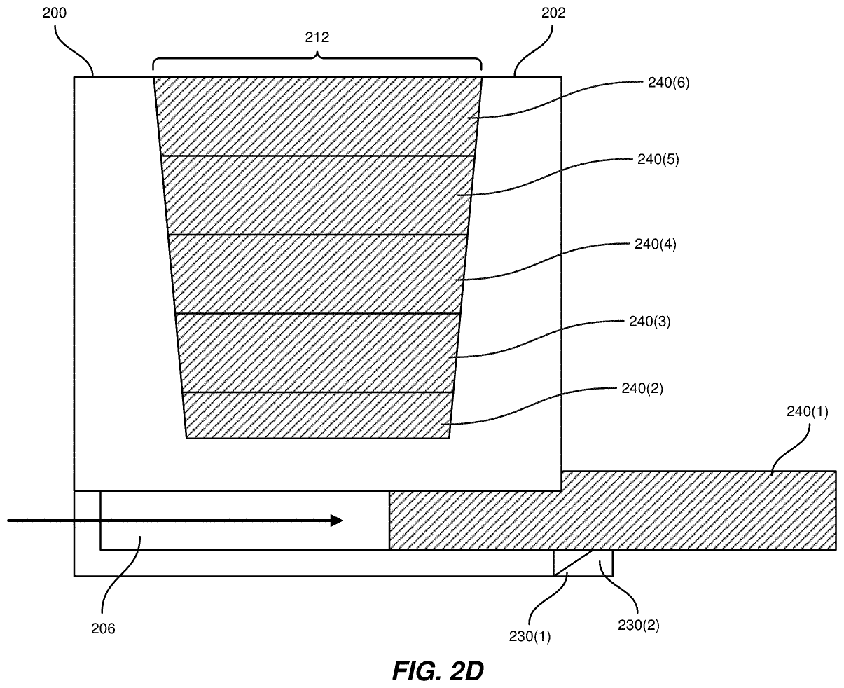

The following will provide, with reference to FIG. 2A, detailed descriptions of an exemplary tape holder apparatus for holding tape cartridges. Detailed descriptions of an alternative exemplary tape holder apparatus will be provided in connection with FIGS. 2B-2C. In addition, detailed descriptions of an exemplary dispensing of exemplary tape cartridges from the exemplary tape holder apparatus will be provided in connection with FIG. 2D.

FIG. 2A illustrates a perspective view of an exemplary tape holder apparatus 200 for holding tape cartridges. In this example, tape holder apparatus 200 may include a cubical tape holder 202, dimensioned to hold multiple tape cartridges in a stack, wherein a tape cartridge is inserted into an open top 204 of cubical tape holder 202 from a horizontal orientation. Tape holder apparatus 200 may also include a horizontal slot 206, open along a bottom edge of two consecutive faces 210(1) and 210(2) of cubical tape holder 202. Horizontal slot 206 may be dimensioned to permit a single tape cartridge at a bottom of the stack to be pushed out from cubical tape holder 202. Additionally, tape holder apparatus 200 may include a handle 208 vertically oriented and extruded from a third face 210(3) of cubical tape holder 202.

In some embodiments, open top 204 may be dimensioned based on a size of a tape cartridge, such as the area of the largest face of an LTO cartridge. In these embodiments, a user may hold a tape cartridge in a substantially horizontal or flat orientation and drop the tape cartridge into cubical tape holder 202. Additionally, tape cartridges may be inserted into cubical tape holder 202 individually or as a stack of tape cartridges.

In one example, horizontal slot 206 may be open at faces 210(1) and 210(2) that do not include handle 208. In this example, horizontal slot 206 may be open along two consecutive bottom edges of cubical tape holder 202 at a front face and a side face to enable individual tape cartridges to be pushed out, one at a time, through the front face to be loaded into a tape library when the front face is oriented to face an open tape library slot. In other words, the user may use a finger to push an exposed back edge of the tape cartridge along face 210(1) of FIG. 2A and out through face 210(2). In this example, only a corner of the back edge of the tape cartridge may be exposed through horizontal slot 206, and the user may exert a continuous force against the back corner, sliding along horizontal slot 206 at face 210(1), until the tape cartridge is fully loaded.

In one embodiment, horizontal slot 206 may be dimensioned as an opening larger than a thickness of the tape cartridge at the front face (i.e., face 210(2) in FIG. 2A). However, at the side face that enables the user to push the tape cartridge, horizontal slot 206 may be dimensioned as an opening smaller than the thickness of the tape cartridge to prevent accidental slip through face 210(1). As illustrated in FIG. 2A, face 210(1) may include an overhang to partially obstruct horizontal slot 206.

In some examples, an opening 212 may be dimensioned to extend down from a top edge of a first face (e.g., face 210(1) in FIG. 2A) of cubical tape holder 202, such that a portion of a side of at least one tape cartridge inserted into cubical tape holder 202 is exposed. In these examples, tape cartridges held by tape holder apparatus 200 may include labels or other identifying features that may be read by exposed opening 212. Additionally or alternatively, opening 212 may enable the user to remove tape cartridges from cubical tape holder 202 via open top 204 by grasping an exposed side of a tape cartridge through opening 212.

FIG. 2B illustrates a perspective view of an alternative exemplary tape holder apparatus 220. In this example, tape holder apparatus 220 may include similar elements as tape holder apparatus 200, such as cubical tape holder 202, open top 204, horizontal slot 206, handle 208, and opening 212. However, handle 208 of tape holder apparatus 220 may be dimensioned at a face 210(4) rather than face 210(3) of FIG. 2A. In this example, the user may hold handle 208 from the back of tape holder apparatus 220 while dispensing tape cartridges toward the front of tape holder apparatus 220 rather than holding handle 208 at a side.

In the above examples, tape holder apparatus 220 and/or tape holder apparatus 200 may be held in the user's left hand while tape cartridges are pushed out from horizontal slot 206 by the user's right hand. In other examples, tape holder apparatus 220 and/or tape holder apparatus 200 may be designed with mirrored features to enable handle 208 to be held in the user's right hand while tape cartridges are pushed through horizontal slot 206 by the user's left hand. Determining whether such features are mirrored may depend on left-handed versus right-handed users or on tape libraries and/or racks that open from the left versus the right side.

FIG. 2C illustrates an alternative perspective view of alternative exemplary tape holder apparatus 220. In one embodiment, tape holder apparatus 220 may include protrusions 230(1)-(2) at face 210(2) of horizontal slot 206. In this embodiment, protrusions 230(1)-(2) may extend from tape holder apparatus 220 as guides for dispensing a tape cartridge out and into a tape library slot. For example, protrusions 230(1)-(2) may guide the tape cartridge directly forward toward the tape library slot and may prevent the tape cartridge from sliding to one side or dropping down as the user exerts force on the tape cartridge. In other examples, protrusions 230(1)-(2) may be dimensioned to align and/or lock to the outside of a tape library slot to hold tape holder apparatus 220 steady while the user loads a tape cartridge. For example, the user may hold handle 208 to position tape holder apparatus 220 forward toward the tape library slot, and protrusions 230(1)-(2) may match features of the tape library slot to lock into place.

FIG. 2D illustrates a side view of exemplary tape holder apparatus 200 dispensing exemplary tape cartridges 240(1)-(6). In some embodiments, cubical tape holder 202 may be dimensioned to hold six tape cartridges, as shown in FIG. 2D. In other embodiments, cubical tape holder 202 may be dimensioned to hold more or fewer tape cartridges. In the example of FIG. 2D, opening 212 may only expose tape cartridges 240(2)-(6) and not tape cartridge 240(1). In other examples, opening 212 may also expose tape cartridge 240(1) or may expose fewer tape cartridges.

As shown in FIG. 2D, the user may exert a horizontal force on tape cartridge 240(1) to push a back side of tape cartridge 240(1) forward and out along horizontal slot 206 at the front face of tape holder apparatus 200, which may be oriented to face an open tape library slot for loading tape cartridge 240(1) into the tape library. In this example, tape cartridges 240(1)-(6) may be loaded in a first in, first out (FIFO) order. For example, tape cartridge 240(1) may be the first tape cartridge inserted into cubical tape holder 202, with additional tape cartridges 240(2)-(6) individually inserted in ascending order on top of tape cartridge 240(1). Thus, tape cartridge 240(1) at the bottom of the stack of tape cartridges may then be the first to load into the tape library while additional tape cartridges 240(2)-(6) drop down after tape cartridge 240(1) is dispensed. In other examples, some or all of tape cartridges 240(1)-(6) may be inserted into cubical tape holder 202 as a pre-sorted stack, with tape cartridge 240(1) at the bottom of the stack. In these examples, tape cartridges 240(1)-(6) may continue to be loaded into the tape library from the bottom up.

In some embodiments, a single tape cartridge may be loaded into a tape library slot, and the user may then move tape holder apparatus 200 to face a different tape library slot for the next tape cartridge. In other embodiments, multiple tape cartridges may be loaded into a single tape library slot, and the user may quickly load multiple tape cartridges in order from the bottom up into the same tape library slot. Additionally, after removing a tape cartridge from a tape library slot, the user may insert the tape cartridge back into tape holder apparatus 200 to be held for transfer to a different tape library slot or removal from the tape library.

In some examples, opening 212 may represent a trapezoidal opening, as illustrated in FIGS. 2A-2D. In alternate examples, opening 212 may represent a rectangular opening or an opening of a different shape that exposes the sides of tape cartridges 240(1)-(6). As previously described, opening 212 may enable easy removal of a tape cartridge from the top of tape holder apparatus 200, rather than dispensing from the bottom. Opening 212 may also enable labels, such as barcodes identifying each tape cartridge, to be read or scanned while tape cartridges are held in cubical tape holder 202.

In addition to protrusions 230(1)-(2), tape holder apparatus 200 and/or tape holder apparatus 220 may include alternative or additional structural features that improve the holding or dispensing of tape cartridges. For example, raised edges along the bottom of horizontal slot 206 may prevent accidental dispensing of a tape cartridge until the user forces the tape cartridge over the edge. As another example, beveled top edges of cubical tape holder 202, as shown in FIGS. 2B-2C, may enable easier insertion of tape cartridges when dropped into tape holder apparatus 220. Furthermore, although LTO cartridges have been used by way of example throughout the present disclosure, the tape holder apparatuses described herein may be dimensioned to hold other types of cartridges that may be dispensed one by one, particularly for data library storage.

As discussed throughout the present disclosure, the disclosed tape holder apparatus may provide various advantages over traditional methods of loading tape cartridges into a tape library or data-center rack. For example, the disclosed tape holder apparatus may hold multiple LTO cartridges that may be loaded into a tape library slot in quick succession. By increasing the number of cartridges that can be held in a single tape holder, the tape holder apparatus described herein may save time during the loading of multiple tape cartridges, which may be especially useful when installing a tape library with thousands of tape cartridges. Additionally, by improving the ease of holding multiple tape cartridges and the ease of dispensing a single tape cartridge at a time, the tape holder apparatus described herein may make the handling of tape cartridges easier for users. Furthermore, the disclosed tape holder apparatus may save money by reducing the number of damaged tape cartridges, which would otherwise need to be replaced, that is typically caused by user error in dropping tape cartridges during loading. For example, a handle attached to the tape holder apparatus may lead to a decreased likelihood of dropping and damaging tape cartridges, thereby also providing cost savings when installing the tape library. Thus, the tape holder apparatus may improve the speed and ease of loading tape cartridges into a tape library during initial installation of the tape library as well as for any future loading.

### Example Embodiments

### Example 3

A tape holder apparatus may include: 1) a cubical tape holder, dimensioned to hold multiple tape cartridges in a stack, wherein a tape cartridge is inserted into an open top of the cubical tape holder from a horizontal orientation, 2) a horizontal slot, open along a bottom edge of two consecutive faces of the cubical tape holder, dimensioned to permit a single tape cartridge at a bottom of the stack to be pushed out from the cubical tape holder, and 3) a handle vertically oriented and extruded from a third face of the cubical tape holder.

### Example 4

The tape holder apparatus of Example 3, wherein an opening may be dimensioned to extend down from a top edge of a first face of the cubical tape holder, such that a portion of a side of at least one tape cartridge inserted into the cubical tape holder is exposed.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive video data to be transformed, transform the video data into encoded video data, and output a result of the transformation to a transmitter. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
a processor; and
a memory device comprising instructions that, when executed by the processor, perform a process for video encoding comprising:
receiving, by a computing device, video data to be encoded;
determining, by the computing device, pixels for a first transform unit (TU) of a first prediction unit (PU) of a square shape of the video data;
storing, by the computing device, the pixels in a buffer;
performing, by the computing device, intra-prediction for a second PU by reusing the stored pixels for a second TU of the second PU; and
encoding the video data based on the intra-prediction performed for the second PU.

2. A system comprising:
a video encoder including:
a buffer; and
a physical processor configured to:
receive video data to be encoded;
determine pixels for a first transform unit (TU) of a first prediction unit (PU) of a square shape of the video data;
store the pixels in the buffer;
perform intra-prediction for a second PU by reusing the stored pixels for a second TU of the second PU; and
encode the video data based on the intra-prediction performed for the second PU; or
a tape holder apparatus including:
a cubical tape holder, dimensioned to hold multiple tape cartridges in a stack, wherein a tape cartridge is inserted into an open top of the cubical tape holder from a horizontal orientation;
a horizontal slot, open along a bottom edge of two consecutive faces of the cubical tape holder, dimensioned to permit a single tape cartridge at a bottom of the stack to be pushed out from the cubical tape holder; and
a handle vertically oriented and extruded from a third face of the cubical tape holder.

3. The system of claim 2, wherein an opening is dimensioned to extend down from a top edge of a first face of the cubical tape holder, such that a portion of a side of at least one tape cartridge inserted into the cubical tape holder is exposed.
